(19) United States
(12) Patent Application Publication
(10) Pub. No.: US 2025/0346112 A1
(43) Pub. Date: Nov. 13, 2025

(54) HOLDER FOR A FUEL FILLER NECK

(71) Applicant: Ford Global Technologies, LLC, Dearborn, MI (US)

(72) Inventors: Chris Curtis, Leverkusen (DE); Benedikt Conrady, Frechen (DE); Frank Kotthoff, Erpel (DE); Graham Michael Kudar, Norfolk (GB)

(73) Assignee: Ford Global Technologies, LLC, Dearborn, MI (US)

(21) Appl. No.: 19/177,708

(22) Filed: Apr. 14, 2025

(30) Foreign Application Priority Data
Apr. 30, 2024 (DE) 102024112169.6

(51) Int. Cl. B60K 15/04

(52) U.S. Cl. CPC B60K 15/04; B60K 2015/0474

(57) ABSTRACT

A holder for a fuel filler neck on a motor vehicle, wherein the holder is fastened by a fastening portion to the body structure of a motor vehicle. The holder is distinguished by a step portion designed, such that a holding portion is spaced from the body structure as viewed in the vertical direction. The holding portion has an inclined guide region and a spacer element.

### CROSS-REFERENCE TO RELATED APPLICATION

This application claims foreign priority benefits under 35 U.S.C. § 119(a)-(d) to German Application No. 102024112169.6 filed Apr. 30, 2024, which is hereby incorporated by reference in its entirety.

### FIELD OF THE DISCLOSURE

The present disclosure generally relates to vehicle fuel fillers, and more specifically relates to a holder for a fuel filler neck having a fastening portion configured to fasten the holder to a body structure of a motor vehicle.

### BACKGROUND OF THE DISCLOSURE

In motor vehicles, a fuel filler neck is often situated within in a support pillar for example, on light commercial vehicles. A first portion of the fuel filler neck typically overlaps with a second portion of the fuel filler neck in a transition region, wherein the portions are fluidically coupled there. The two portions may consist of different materials with the first portion typically having an opening into which fuel is introduced, while the second portion connected to a fuel tank. A pipe clamp is often used to clamp the two overlapping portions.

The support pillar may be a vertically load-bearing element in the middle of the motor vehicle, and connects the vehicle floor to the vehicle roof. The support pillar is normally reinforced with respect to the body structure, also with respect to the lower body structure, that is to say with respect to a vehicle floor with a gusset plate.

Fuel filler necks that are arranged with their first portion within the support pillar are often fastened to a holder that is cohesively connected to the first portion and screwed to the body structure, that is to say for example to the vehicle floor.

It would be desirable to provide for an enhanced holder for a fuel filler neck that is arranged at least in part within the support structure.

### SUMMARY OF THE DISCLOSURE

According to a first aspect of the present disclosure, a holder for a fuel filler neck on a motor vehicle has a fastening portion configured to fasten the holder to a body structure of the motor vehicle and a holding portion with an inclined guide region. A spacer element and a step portion are designed such that the holding portion is spaced from the body structure as viewed in a vertical direction.

Embodiments of the first aspect of the present disclosure can include any one or a combination of the following features:
the holder is L-shaped with two mutually perpendicular limbs, one of which is shorter than the other;
in an installed position, the fastening portion is configured to be oriented perpendicular to a sill of the motor vehicle, wherein the holding portion is arranged to extend parallel to the sill;
the fastening portion is formed with a planar fastening region, in which there is a centrally arranged bore;
the step portion is formed as an angled transition piece, such that the step portion serves as a predetermined bending element;
the step portion continues with a planar lever arm which is seamlessly adjoined by the holding portion;
the holding portion has a guide arm which adjoins the planar lever arm and on an end of which the inclined guide region is arranged;
reinforcement elements arranged in the holding portion;
the spacer element is fastened to a side situated opposite the inclined guide region;
the spacer element is designed as a hollow profile;
the spacer element is designed as a rectangular profile element which is longer than it is tall and wide and which is also wider than it is tall;
the spacer element has a longitudinal extent shorter than that of the holding portion;
the holding portion has a holding region configured to be fixed with the fuel filler neck;
the holding region has at least one holding clip and a holding bracket situated opposite the holding clip; and
the holder is designed such that, when acted on by a gusset that engages under the holder, the holder bends in a direction of a surface on which the motor vehicle is standing, and the holder moves the spacer element arranged thereon such that the spacer element is situated between a transition region of the fuel filler neck and a connection region of a longitudinal member and a transverse member of the motor vehicle.

According to a second aspect of the present disclosure, a holder for a fuel filler neck on a motor vehicle has a fastening portion configured to fasten the holder to a body structure of the motor vehicle. In an installed position, the fastening portion is oriented perpendicular to a sill of the motor vehicle. The holding portion is arranged so as to extend parallel to the sill. The holder may also include a holding portion having an inclined guide region and a spacer element. The holding portion has a guide arm which adjoins the planar lever arm and on an end of which the inclined guide region is arranged. A step portion is designed such that the holding portion is spaced from the body structure as viewed in a vertical direction. The step portion is formed as an angled transition piece, such that the step portion serves as a predetermined bending element. The step portion continues with a planar level arm which is seamingly adjoined by the holding portion. The holding portion has a guide arm which adjoins the planar level arm.

Embodiments of the second aspect of the present disclosure can include any one or a combination of the following features:
the holder is L-shaped with two mutually perpendicular limbs, one of which is shorter than the other;
reinforcement elements are arranged in the holding portion; and
the spacer element is fastened to a side situated opposite the inclined guide region.

According to a third aspect of the present disclosure, a motor vehicle has a body structure, a fuel filler neck and a holder for the fuel filler neck. The holder includes a fastening portion configured to fasten the holder to the body structure of the motor vehicle, a holding portion having an inclined guide region and a spacer element and a step portion. The step portion is designed such that the holding portion is spaced from the body structure as viewed in a vertical direction.

These and other features, advantages, and objects of the present disclosure will be further understood and appreciated by those skilled in the art by reference to the following specification, claims, and appended drawings.

### BRIEF DESCRIPTION OF THE DRAWINGS

In the drawings:

FIG. 1 is an upper perspective view of a holder for a fuel filler neck having the fuel filler neck held thereon;

FIG. 2 is an upper perspective view of the holder for a fuel filler neck shown in FIG. 1;

FIG. 3 is an upper perspective view of the holder for a fuel filler neck from FIG. 1 installed on a body structure of a motor vehicle, viewed from the direction of an underlying surface on which the motor vehicle is standing; and

FIG. 4 is an upper view of FIG. 3 in a view rotated in relation to FIG. 3.

### DETAILED DESCRIPTION OF PREFERRED EMBODIMENTS

Reference will now be made in detail to the present preferred embodiments of the disclosure, examples of which are illustrated in the accompanying drawings. Wherever possible, the same reference numerals will be used throughout the drawings to refer to the same or like parts. In the drawings, the depicted structural elements are not to scale and certain components are enlarged relative to the other components for purposes of emphasis and understanding.

As required, detailed embodiments of the present disclosure are disclosed herein; however, it is to be understood that the disclosed embodiments are merely exemplary of the disclosure that may be embodied in various and alternative forms. The figures are not necessarily to a detailed design; some schematics may be exaggerated or minimized to show function overview. Therefore, specific structural and functional details disclosed herein are not to be interpreted as limiting, but merely as a representative basis for teaching one skilled in the art to variously employ the present disclosure.

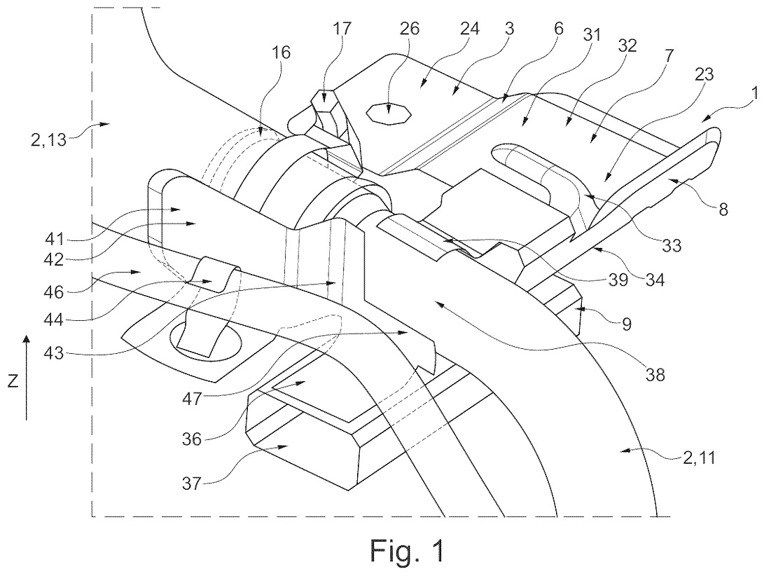

For purposes of description herein, the terms “upper,” “lower,” “right,” “left,” “rear,” “front,” “vertical,” “horizontal,” and derivatives thereof shall relate to the concepts as oriented in FIG. 1. However, it is to be understood that the concepts may assume various alternative orientations, except where expressly specified to the contrary. It is also to be understood that the specific devices and processes illustrated in the attached drawings, and described in the following specification are simply exemplary embodiments of the inventive concepts defined in the appended claims. Hence, specific dimensions and other physical characteristics relating to the embodiments disclosed herein are not to be considered as limiting, unless the claims expressly state otherwise.

The present illustrated embodiments reside primarily in combinations of method steps and apparatus components related to a holder for a fuel filler neck for a motor vehicle. Accordingly, the apparatus components and method steps have been represented, where appropriate, by conventional symbols in the drawings, showing only those specific details that are pertinent to understanding the embodiments of the present disclosure so as not to obscure the disclosure with details that will be readily apparent to those of ordinary skill in the art having the benefit of the description herein. Further, like numerals in the description and drawings represent like elements.

As used herein, the term “and/or,” when used in a list of two or more items, means that any one of the listed items can be employed by itself, or any combination of two or more of the listed items, can be employed. For example, if a composition is described as containing components A, B, and/or C, the composition can contain A alone; B alone; C alone; A and B in combination; A and C in combination; B and C in combination; or A, B, and C in combination.

In this document, relational terms, such as first and second, top and bottom, and the like, are used solely to distinguish one entity or action from another entity or action, without necessarily requiring or implying any actual such relationship or order between such entities or actions. The terms “comprises,” “comprising,” or any other variation thereof, are intended to cover a non-exclusive inclusion, such that a process, method, article, or apparatus that comprises a list of elements does not include only those elements but may include other elements not expressly listed or inherent to such process, method, article, or apparatus. An element preceded by “comprises . . . a” does not, without more constraints, preclude the existence of additional identical elements in the process, method, article, or apparatus that comprises the element.

As used herein, the term “about” means that amounts, sizes, formulations, parameters, and other quantities and characteristics are not and need not be exact, but may be approximate and/or larger or smaller, as desired, reflecting tolerances, conversion factors, rounding off, measurement error and the like, and other factors known to those of skill in the art. When the term “about” is used in describing a value or an end-point of a range, the disclosure should be understood to include the specific value or end-point referred to. Whether or not a numerical value or end-point of a range in the specification recites “about,” the numerical value or end-point of a range is intended to include two embodiments: one modified by “about,” and one not modified by “about.” It will be further understood that the end-points of each of the ranges are significant both in relation to the other end-point, and independently of the other end-point.

The terms “substantial,” “substantially,” and variations thereof as used herein are intended to note that a described feature is equal or approximately equal to a value or description. For example, a “substantially planar” surface is intended to denote a surface that is planar or approximately planar. Moreover, “substantially” is intended to denote that two values are equal or approximately equal. In some embodiments, “substantially” may denote values within about 10% of each other, such as within about 5% of each other, or within about 2% of each other.

As used herein the terms “the,” “a,” or “an,” mean “at least one,” and should not be limited to “only one” unless explicitly indicated to the contrary. Thus, for example, reference to “a component” includes embodiments having two or more such components unless the context clearly indicates otherwise.

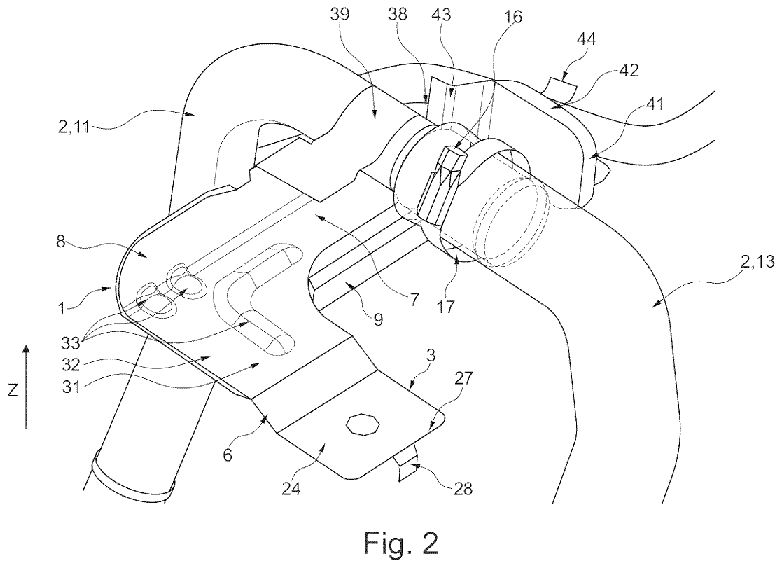

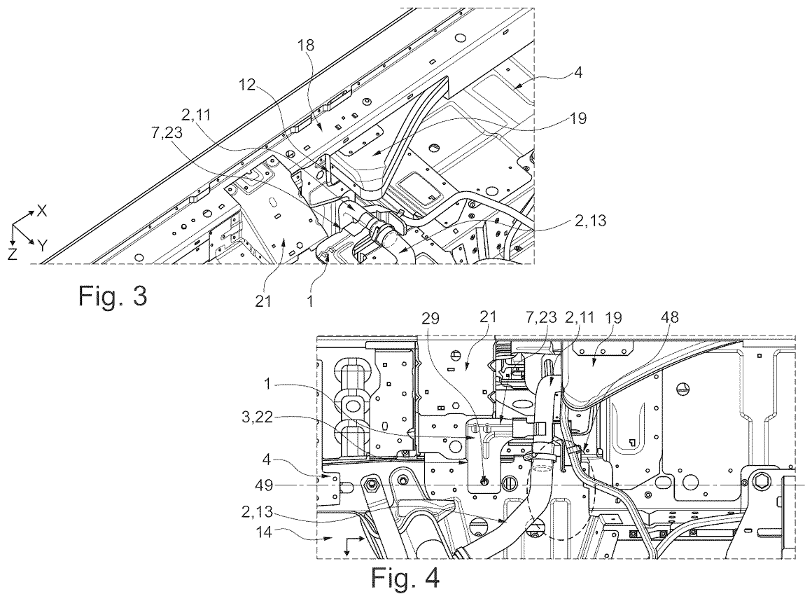

FIG. 1 shows a holder 1 for a fuel filler neck 2, wherein the holder 1 is fastened by a fastening portion 3 to a body structure 4 shown in FIGS. 3 and 4 of a motor vehicle (not illustrated). The holder 1 has a step portion 6 designed such that a holding portion 7 of the holder 1 is spaced from the body structure 4 as viewed in the vertical direction Z, wherein the holding portion 7 has an inclined guide region 8 and a spacer element 9. The vertical direction Z is perpendicular to the plane of the drawing in FIGS. 3 and 4, and is indicated by the directional arrow in FIGS. 1 and 2.

The fuel filler neck 2 has a neck portion 11 that has an opening for the introduction of fuel. The neck portion 11 is arranged so as to extend in the interior of a support pillar 12 (FIGS. 3 and 4) of the motor vehicle which may be a middle or rear vertical support pillar. On that side of the body structure 4 which faces toward an underlying surface on which the motor vehicle is standing, said side also being referred to as vehicle floor or underbody, the neck portion 11 is led away from the support pillar 12. The fuel filler neck 2 also has a neck portion 13 that is connected to a fuel tank 14 (FIG. 4). The two neck portions 11 and 13 are fluidically coupled to one another in a transition region 16. For this purpose, the two neck portions 11 and 13 overlap in the transition region 16, and a pipe clamp 17 is provided for fastening the two neck portions 11 and 13 by clamping these. The transition region 16 of the fuel filler neck 2 is fixed to the holding portion 7 of the holder 1, as will be discussed in more detail.

FIGS. 3 and 4 also show a sill 18 of the motor vehicle, and a sliding door pocket 19 arranged on the sill. A gusset 21 or gusset plate is arranged on the sill 18 and on the body structure 4 in the region of the support pillar 12. As can be seen in FIG. 3, the gusset 21 extends in inclined fashion from the sill 18 in the direction of the body structure 4.

As is illustrated by way of example in the figures, the holder 1 is L-shaped with two mutually perpendicular limbs 22, 23, one of which is shorter than the other. The fastening portion 3 together with the step portion 6 forms the shorter L limb 22 of the two L limbs, and the holding portion 7 forms the longer L limb 23 of the two L limbs. In the installed position as illustrated in FIGS. 3 and 4, the fastening portion 3 is oriented perpendicular to the sill 18 of the motor vehicle. As can be seen, the holding portion 7 is for example arranged so as to extend parallel to the sill 18.

As can be seen most clearly in FIGS. 1 and 2, the fastening portion 3 is formed with a planar fastening region 24, in which there is a centrally arranged bore 26. The fastening region 24 is for example tetragonal with rounded corners and, at its end 27 situated opposite the step portion 6, has for example a twist prevention feature 28, for example a tab, that can engage into a corresponding recess, for example a slot, in the body structure 4. The twist prevention feature 28 can be seen in FIG. 2. The holder 1 is fastened, that is to say screwed, to the body structure 4 by use of a screw 29 that extends through the bore 26, as can be seen most clearly in FIG. 4.

FIGS. 1 and 2 show that the step portion 6 is formed as an angled transition piece, such that the step portion 6 advantageously serves as a predetermined bending element. A hinge is thus formed, at which the holder 1 can bend in the vertical direction when correspondingly acted on by the aforementioned gusset 21. In particular, the step portion 6 is continued with a planar lever arm 31 which is seamlessly adjoined by the holding portion 7.

By way of example, the holding portion 7 has a guide arm 32 which adjoins the planar lever arm 31 and on the end of which the inclined guide region 8 is arranged. By way of example, the guide region 8 is designed as an inclined flange projection that is bent away from the guide arm 32. For example, relative to the lever and guide arms 31, 32, which are each planar, the guide region 8 has an inclination adapted to the inclination of the gusset 21 arranged on the sill 18, wherein, for example, an inclination of more than 45°, preferably more than 60° and more preferably more than 75° may be provided. A guide region 8 is thus formed which is correspondingly adapted to the profile of the gusset 21, such that said gusset, engaging on the guide region 8, can act on the holder 1 so as to bend it at the predetermined bending line in a lateral force contact event.

As can be seen most clearly in FIGS. 1 and 2, the holder 1 has reinforcement elements 33, designed for example as rib-like elevations. These are arranged for example in the holding portion 7, for example in the region of the guide arm 32. As can be seen, the step portion 6 is kept free from reinforcement elements. In particular, the reinforcement elements 33 may be formed as elevations oriented in the vertical direction Z like the guide region 8 as viewed in the longitudinal direction of the holding portion 7, and/may be formed so as to extend parallel or at an angle with respect to this in the holding portion 7, as can be seen in FIGS. 1 and 2.

As mentioned above, the holding portion 7 has the spacer element 9. As can be seen most clearly in FIGS. 1 and 2, the spacer element 9 is fastened to the underside 34, situated opposite the guide region 8, of the holder 1, as can be seen most clearly in FIG. 1. The underside 34 is oriented toward the body structure 4. To fasten the spacer element 9, holding elements 36 are arranged on the underside 34 of the holder 1, that is to say on the holding portion 7. The spacer element 9 is cohesively connected to the associated holding element 36, with the holding elements 36 abutting against the spacer element 9.

The spacer element 9 is designed for example as a hollow profile. As can be seen, the spacer element 9 is designed as a rectangular profile element which is longer than it is tall and wide and which is also wider than it is tall. For example, the spacer element 9 is designed as an elongate rectangular profile that is open to both sides at its end faces 37.

For example, the spacer element 9 is adapted at least in terms of its longitudinal extent to the design of the holding portion 7, which in the installed state extends parallel to the sill 18. As illustrated for example in FIGS. 1 and 2, the spacer element 9 has a longitudinal extent shorter than that of the holding portion 7. This is intended to achieve that the spacer element 9 is kept away from the guide region 8.

For the purposes of fastening the fuel filler neck 2, in particular the transition region 16 thereof, the holding portion 7 has a holding region 38. In particular, the holding region 38 is arranged adjacent to the guide region 8.

For example, the holding region 38 has a holding clip 39 and a holding bracket 41 situated opposite said holding clip. The holding clip 39 is provided for fastening that neck portion 11 of the fuel filler neck 2 which has the introduction opening. The holding clip 39 surrounds the associated neck portion 11 across the zenith of the neck portion 11 in the circumferential direction. The holding clip 39 can be deflected counter to a spring force that is intrinsic therein. The holding bracket 41 furthermore has an abutment bracket 42 and a spring bracket 43. The holding bracket 41 bears by way of the spring bracket 43 against the associated neck portion 11, in particular opposite the point at which the holding clip 39 abuts against the associated neck portion 11. As can be seen most clearly in FIG. 1, the spring bracket 43 is continued with an abutment projection 47 of reduced height. The abutment projection 47 also bears against the neck portion 11. The holding clip 39 and the spring bracket 43 are designed and arranged relative to one another so as to interact such that the neck portion 11 held therein is held in a stable position at least for installation purposes. In particular, the holding clip 39 and the holding bracket 41, in particular the spring bracket 43 thereof and the abutment projection 47, may be cohesively connected to the neck portion 11, wherein a welded connection or an adhesive connection may be used, such that a positionally stable fastening can be achieved. Although in principle the spring bracket 43 does not need to have a spring action, and this therefore also applies to the holding clip 39, both are preferably welded to the neck portion 11.

For example, a holding device 44, for example for a ventilation hose 46, may also be arranged on the holding bracket 41, that is to say on its abutment bracket 42 opposite the side that bears against the neck portion 11. The holding bracket 41 also has a further function. The holding bracket serves to protect the fuel filler neck 2, that is to say its transition region 16, in particular the pipe clamp 17, from the sliding door pocket 19 arranged on the sill 18, if the sliding door pocket moves owing to the lateral force contact event.

In a lateral event of a particular type, the holder 1 may function as follows:

A laterally contacting element may push the body structure 4, and the holder 1 and the fuel filler neck 2 fastened to the holder, firstly in the direction of a vehicle central axis, that is to say inward. A connection region 48 between a longitudinal member and a transverse member may also concertina under compression, that is to say form a corrugation peak that is oriented away from the body structure in the direction of the underlying surface on which the motor vehicle is standing, that is to say in the direction of the fuel filler neck 2, in particular its transition region 16. The connection region 48 of longitudinal member and transverse member, which is not visible in the figures, is highlighted in FIG. 4 by the region shown using dashed lines. A possible arrangement of the longitudinal member is indicated in FIG. 4 by the dashed line 49. Owing to the vertical height difference created by the step portion 6, the action of the gusset 21 that engages under the holder 1 causes the holder to be bent downward, that is to say in the direction of the underlying surface on which the motor vehicle is standing, and to thus also move the spacer element 9. In other words, the fuel filler neck 2, in particular its transition region 16, is moved in the direction of the underlying surface on which the motor vehicle is standing, that is to say is moved out of the region of action of the possibly concertinaing connection region 48 of longitudinal member and transverse member, that is to say said fuel filler neck is lifted out of the possible region of action of the longitudinal member. Although the term “lifted out” is used here, it is pointed out once again that this constitutes a movement oriented away from the body structure in the direction of the underlying surface, that is to say effectively downward. Here, owing to the design of the holder 1, the movement direction may always be identical even if the laterally contacting element is situated in a different position. The spacer element 9 is situated between the fuel filler neck 2, in particular its transition region 16, and the connection region 48 of longitudinal member and transverse member, which connection region, in a lateral In a lateral event of a particular type, the holder 1 may function as follows: force contact event, concertinas and could make contact with the transition region, which is advantageously prevented. The spacer element 9 holds the transition region 16 away from these parts (longitudinal member, connection region 48) and thus prevents an unwanted deformation of the fuel filler neck 2. The sliding door pocket 19 arranged on the sill 18 of the motor vehicle, said sliding door pocket also being shielded by the holding bracket 41, the remains free from contact with the transition region 16.

A holder for a fuel filler neck is disclosed which is fastened by a fastening portion to a body structure of a motor vehicle. The holder is distinguished by a step portion designed such that a holding portion is spaced from the body structure as viewed in the vertical direction, wherein the holding portion has an inclined guide region and a spacer element.

Note that the features and measures individually specified in the following description may be combined with one another in any technically meaningful way and reveal further refinements of the disclosure. The description additionally characterizes and specifies the holder, in particular in conjunction with the figures.

In the context of the disclosure, motor vehicles are any externally powered vehicles that are passenger motor vehicles, vans, pickups, buses, light commercial vehicles or heavy goods vehicles that can be propelled using internal combustion engines or hybrid drives. In the context of the disclosure, the body structure is in particular a vehicle floor that adjoins a vehicle sill, that is to say a longitudinal member, to the inside. In particular, the fuel filler neck is arranged at least in part within a support pillar.

The disclosure presents a holder for a fuel filler neck of a motor vehicle. Here, the holder according to the disclosure is a sheet-metal part that has the step portion produced for example by deformation. The inclined guide region is also provided for example by deformation. Only the spacer element is a separate element, which is cohesively connected to the holder, in particular at its side facing toward the body structure. The holder is fastened, in particular screwed, by the fastening portion to the body structure.

The holder has the step portion, which creates a vertical difference between the fastening point, that is to say screw connection point, and the rest of the holder. This means that during a lateral force contact event, the holder, when acted on by a corresponding lever, bends away from the body structure in the direction of an underlying surface on which the motor vehicle is standing. Since the rest of the holder remains relatively undeformed, there are no sharp or bent edges in the vicinity of the fuel filler neck.

The holder has the inclined guide region, which can also be referred to as a ramp and which in an ideal refinement comes into contact with a gusset arranged on a sill. The gusset corresponds to the lever discussed above, and in the possible region of contact has a correspondingly designed counterpart inclination or counterpart ramp, which in the event of contact causes the holder together with the fuel filler neck fastened thereto to be deflected out of the initial position in a vertical direction. In particular, a movement oriented toward the front of the vehicle can also be generated. As a result of this vertical movement together with the forward movement, the transition region, that is to say the overlap of the two neck portions of the fuel filler neck, is, as viewed in the vertical direction, moved away from the body structure in the direction of the underlying surface on which the motor vehicle is standing, and out of the possible region of contact with the connection region of a longitudinal member and a transverse member, which connection region forms a corrugation, that is to say concertinas, so to speak. Owing to the two corresponding ramps, the gusset plunges underneath the holder, so to speak, and effectively lifts the holder. In the process, the holding portion is moved vertically towards the underlying surface on which the motor vehicle standing.

The spacer element according to the disclosure, in interaction with the ramp and the step portion, contributes to the behavior of the fuel filler neck in an extreme event, for example in a lateral force contact event in the region of a support pillar. Owing to its high rigidity, the spacer element acts as a spacer between the holder and the body structure. The spacer element has a further function, specifically as a sacrificial element. Specifically, the spacer element prevents the fuel filler neck, in particular the transition region thereof, from making contact with the concertinaing connection region of longitudinal member and transverse member, and thus also prevents against possible deformation. The spacer element furthermore keeps the holding portion of the holder free from deformation. The spacer element thus also has a third function, namely the function of a reinforcement element.

In a lateral event, the mechanism of the holder may function as follows:

A laterally contacting element may push the body structure, and the holder fastened thereto together with the fuel filler neck fastened to the holder, firstly in the direction of a vehicle central axis, that is to say inward. Furthermore, the connection region between the longitudinal member and the transverse member may concertina, that is to say form a corrugation. Owing to the vertical height difference created by the step portion, the action of the gusset that engages under the bracket causes the bracket to be bent, that is to say bent in the direction of the underlying surface on which the motor vehicle is standing, and to thus also move the spacer element. Here, owing to the design of the bracket, the movement direction is always identical even if the laterally contacting element is situated in a different position. The spacer element is situated between the fuel filler neck, in particular the transition region thereof, and the connection region of longitudinal member and transverse member. The spacer element holds the overlap region away from these parts. A sliding door pocket that could be arranged on the longitudinal member of the motor vehicle also remains free from contact with the overlap region, which could expediently be achieved by means of a holding bracket arranged on the holder.

In one refinement, the holder is L-shaped with two mutually perpendicular limbs, one of which is shorter than the other. The fastening portion together with the step portion forms the shorter of the two L limbs, and the holding portion forms the longer of the two L limbs. In the installed position, the fastening portion is in particular oriented perpendicular to the sill of the motor vehicle. The holding portion is then for example arranged so as to extend parallel to the sill.

In a further refinement, the fastening portion is formed with a planar fastening region, in which there is a centrally arranged bore. The fastening region in particular polygonal, for example tetragonal, and at its end situated opposite the step portion has for example a twist prevention feature that engages into a corresponding recess, for example a slot, in the body structure. The holder is thus mounted in captively retained fashion at least for installation purposes. The holder is fastened, that is to say screwed, to the body structure in particular by use of a screw that extends through the bore. Instead of a preferably polygonal design, the fastening region may self-evidently also be of some other suitable design, wherein a round or elliptical design may be used, though these are self-evidently merely examples.

In another refinement, step portion is formed as an angled transition piece, such that the step portion advantageously serves as a predetermined bending element. A hinge is thus formed, at which the holder can bend in the vertical direction when correspondingly acted on by the aforementioned gusset. The step portion is continued with a planar lever arm which is seamlessly adjoined by the holding portion.

In another refinement, the holding portion has a guide arm which adjoins the planar lever arm and on the end of which the inclined guide region is arranged. In a further refinement, the guide region is designed as an inclined flange projection that is bent away from the guide arm. In particular, relative to the planar lever and guide arms, the guide region may have an inclination adapted to the inclination of the gusset arranged on the sill, wherein an inclination of more than 45°, preferably more than 60° and more preferably more than 75° may be provided, depending on the angle of the gusset. A guide region is thus formed which is correspondingly adapted to the profile of the gusset, such that said gusset, engaging on the guide region, acts on the holder so as to bend it at the predetermined bending line.

To reinforce the holder, it is expedient in the context of the disclosure if reinforcement elements are provided, for example as rib-like elevations, on the holder, preferably in the holding portion, more preferably in the region of the guide arm. Here, in an ideal refinement, the step portion may be kept free from reinforcement elements. In particular, the reinforcement elements may be arranged on the holder as rib-like elevations extending in the vertical direction like the guide region as viewed in the longitudinal direction of the holding portion, and/may be formed so as to extend parallel or at an angle with respect to this in the holding portion.

As mentioned above, the holding portion has the spacer element. In one refinement, the spacer element is fastened to the underside, situated opposite the guide region, of the holder. In relation to an installed position on the body structure, the underside refers to the side oriented toward the body structure. Holding brackets may be provided for fastening purposes. The spacer element is expediently formed from a material of the same type as the holder. The spacer element can thus be manufactured separately and preferably cohesively connected to the holder without great effort. If the holder consists of a metal plate, it is expedient for the spacer element also be formed from a metal. A welded connection may be expedient as a cohesive connection. An adhesive connection is also conceivable. Instead of using materials of the same type, the two elements may self-evidently also be formed from materials of different types, for example from plastics materials, but it is preferable for the holder to be formed from a flexible and weldable metal plate and for the spacer element to be produced from a weldable metal plate.

In a further refinement, the spacer element is formed as a hollow profile. This refinement has a positive effect on the rigidity of the spacer element and thus of the holder. In yet a further refinement, the spacer element is designed as a rectangular profile element, which in a yet further refinement is longer than it is tall and wide and is also wider than it is tall. In particular, the spacer element is designed as an elongate rectangular profile that may be open to one side or to both sides at its end faces. The spacer element could self-evidently also be designed as a solid profile. Other geometrical designs for the spacer element are also possible. For example, the spacer element may be designed as a round or elliptical hollow cylinder, which may be open to one side or to both sides.

It is expedient if the spacer element is adapted, at least in terms of its longitudinal extent which extends parallel to the longitudinal member in the installed state, to the design of the holding portion. In a yet further refinement, the spacer element has a longitudinal extent shorter than that of the holding portion. This is intended to achieve that the spacer element is kept away from the guide region.

For the purposes of fastening the fuel filler neck, in particular its transition region at which a first neck portion overlaps with a second neck portion, the holding portion has a holding region. In particular, the holding region is arranged adjacent to the guide region. The overlapping neck portions are fastened to one another by use of a pipe clamp. The spacer element is directly assigned to the holding region. The protection thereof, and also the protection of the transition region of the two neck portions, is thus particularly effective.

It is expedient if the holding region has at least one holding clip, and preferably an oppositely situated holding bracket. The holding clip is provided for fastening one of the neck portions of the fuel filler neck. In particular, that neck portion which has the opening for the introduction of the fuel may be fixed by the clip to the holder. The other neck portion is connected to a fuel tank. In a further refinement, the holding clip surrounds the associated neck portion across the zenith of the neck portion as viewed in the circumferential direction. The holding clip can be deflected counter to a spring force that is intrinsic therein. In a further refinement, the holding bracket has an abutment bracket and a spring bracket. The holding bracket bears by way of the spring bracket against the associated neck portion, in particular opposite the point at which the holding clip abuts against the associated neck portion. The holding clip and the spring bracket are designed and arranged relative to one another so as to interact such that the neck portion held therein is held in a stable position. This can be expedient for installation purposes.

For the purposes of fastening the neck portion to the holder, the neck portion may for example be pressed into the holding region such that, for example, the spring bracket and the holding clip are deflected. In the final position of the neck portion, the spring bracket and holding clip return approximately into their initial position, but also subject the neck portion to the acting spring-back force. The neck portion is thus adequately held in the holding region. For the purposes of fastening the associated neck portion, the holding clip and the holding bracket, in particular the spring bracket thereof, may be cohesively connected to the neck portion. A welded connection or an adhesive connection is expedient. Although in principle the spring bracket does not need to have a spring action, and this therefore also applies to the holding clip, both are preferably welded to the neck portion. A holding device, for example of a ventilation line, may also be arranged on the holding bracket, opposite the side that bears against the neck portion.

It is to be understood that variations and modifications can be made on the aforementioned structure without departing from the concepts of the present disclosure, and further it is to be understood that such concepts are intended to be covered by the following claims unless these claims by their language expressly state otherwise.

What is claimed is:

1. A holder for a fuel filler neck on a motor vehicle, the holder comprising:
a fastening portion configured to fasten the holder to a body structure of the motor vehicle;
a holding portion having an inclined guide region and a spacer element; and
a step portion designed such that the holding portion is spaced from the body structure as viewed in a vertical direction.

2. The holder of claim 1, wherein the holder is L-shaped with two mutually perpendicular limbs, one of which is shorter than the other.

3. The holder of claim 1, wherein in an installed position, the fastening portion is configured to be oriented perpendicular to a sill of the motor vehicle, wherein the holding portion is arranged to extend parallel to the sill.

4. The holder of claim 1, wherein the fastening portion is formed with a planar fastening region, in which there is a centrally arranged bore.

5. The holder of claim 1, wherein the step portion is formed as an angled transition piece, such that the step portion serves as a predetermined bending element.

6. The holder of claim 1, wherein the step portion continues with a planar lever arm which is seamlessly adjoined by the holding portion.

7. The holder of claim 6, wherein the holding portion has a guide arm which adjoins the planar lever arm and on an end of which the inclined guide region is arranged.

8. The holder of claim 1, further comprising reinforcement elements that are arranged in the holding portion.

9. The holder of claim 1, wherein the spacer element is fastened to a side situated opposite the inclined guide region.

10. The holder of claim 1, wherein the spacer element is designed as a hollow profile.

11. The holder of claim 1, wherein the spacer element is designed as a rectangular profile element which is longer than it is tall and wide and which is also wider than it is tall.

12. The holder of claim 1, wherein the spacer element has a longitudinal extent shorter than that of the holding portion.

13. The holder of claim 1, wherein the holding portion has a holding region configured to be fixed with the fuel filler neck.

14. The holder of claim 13, wherein the holding region has at least one holding clip and a holding bracket situated opposite the holding clip.

15. The holder of claim 1, wherein the holder is designed such that, when acted on by a gusset that engages under the holder, the holder bends in a direction of a surface on which the motor vehicle is standing, and the holder moves the spacer element arranged thereon such that the spacer element is situated between a transition region of the fuel filler neck and a connection region of a longitudinal member and a transverse member of the motor vehicle.

16. A holder for a fuel filler neck on a motor vehicle, the holder comprising:
a fastening portion configured to fasten the holder to a body structure of the motor vehicle, wherein in an installed position, the fastening portion is oriented perpendicular to a sill of the motor vehicle, wherein the holding portion is arranged so as to extend parallel to the sill;
a holding portion having an inclined guide region and a spacer element, wherein the holding portion has a guide arm which adjoins the planar lever arm and on an end of which the inclined guide region is arranged; and
a step portion designed such that the holding portion is spaced from the body structure as viewed in a vertical direction, wherein the step portion is formed as an angled transition piece, such that the step portion serves as a predetermined bending element, wherein the step portion continues with a planar level arm which is seamingly adjoined by the holding portion, and wherein the holding portion has a guide arm which adjoins the planar level arm.

17. The holder of claim 16, wherein the holder is L-shaped with two mutually perpendicular limbs, one of which is shorter than the other.

18. The holder of claim 16, further comprising reinforcement elements that are arranged in the holding portion.

19. The holder of claim 16, wherein the spacer element is fastened to a side situated opposite the inclined guide region.

20. A motor vehicle comprising:
a body structure;
a fuel filler neck; and
a holder for the fuel filler neck, the holder comprising:
a fastening portion configured to fasten the holder to the body structure of the motor vehicle;
a holding portion having an inclined guide region and a spacer element; and
a step portion designed such that the holding portion is spaced from the body structure as viewed in a vertical direction.
